(19) United States
(12) Patent Application Publication
(10) Pub. No.: US 2013/0284071 A1
(43) Pub. Date: Oct. 31, 2013

(54) COMPOSITION FOR BUILDING MATERIALS HAVING IMPROVED FREEZE-THAW RESISTANCE AND PROCESS FOR THE PRODUCTION THEREOF

(71) Applicants: Manuel Friedel, Zurich (CH); Giovanni Martinola, Buchs (CH); Stefan Meier, Wollerau (CH)

(72) Inventors: Manuel Friedel, Zurich (CH); Giovanni Martinola, Buchs (CH); Stefan Meier, Wollerau (CH)

(73) Assignee: Evonik Degussa GmbH, Essen (DE)

(21) Appl. No.: 13/989,205

(22) PCT Filed: Nov. 24, 2011
(86) PCT No.: PCT/EP2011/070890

§ 371 Date: Jun. 25, 2013

(30) Foreign Application Priority Data
Dec. 20, 2010 (DE) 10 2010 063 561.8

(51) Int. Cl. C04B 7/345

(52) U.S. Cl. CPC C04B 7/345
USPC 106/708; 524/269

(57) ABSTRACT

A hydraulically curable composition, in particular for the production of concrete, mortar, screed, or render having improved freeze-thaw resistance, as well as a process for producing the composition. The composition includes the constituents cement, additional constituents, and organofunctional silicon compounds, and optionally aggregates and admixtures. The composition also contains the additional constituents fly ash and silica dust, in each case independently based on the weight of cement, in an amount of from 1 to 25% by weight and the organofunctional silicon compounds in an amount of from 0.1 to 5% by weight based on the weight of cement.

The present application claims priority from PCT Patent Application No. PCT/EP2011/070890 filed on Nov. 24, 2011, which claims priority from German Patent Application No. DE 10 2010 063 561.8 filed on Dec. 20, 2010, the disclosures of which are incorporated herein by reference in their entirety.

### 1. FIELD OF THE INVENTION

The invention relates to a hydraulically curable composition, in particular for the production of concrete, mortar, screed or render having improved freeze-thaw resistance, which comprises the constituents cement, additional constituents, organofunctional silicon compounds and optionally aggregates and optionally admixtures and which contains the additional constituents fly ash and silica dust, in each case independently based on the weight of cement, in an amount of from 1 to 25% by weight and the organofunctional silicon compounds in an amount of from 0.1 to 5% by weight based on the weight of cement. The invention further relates to a process for producing the composition and also to the use of the combination of constituents for improving the freeze-thaw resistance.

It is noted that citation or identification of any document in this application is not an admission that such document is available as prior art to the present invention.

Concrete is based on hydraulically curable compositions which in the simplest case comprise water, cement and rock particles. Concrete is a porous building material which can be characterized by its pore structure. Gel, capillary and air pores contribute to the pore structure. Water can be absorbed by the building material via the pore structure by capillary suction. In the case of concrete, the absorption of water and of harmful materials dissolved therein, in particular chlorides, is one of the main causes of damage and results in corrosion of reinforcement, an alkali-silica reaction and sulphate blowing. At the same time, the pore structure, especially that of the air pores which have a diameter of from 10 μm to 300 μm, is responsible for the resistance of concrete to freeze-thaw cycles. If a concrete has only few or poorly connected air pores, the resistance to freeze-thaw cycles decreases. An air pore former is therefore sometimes added as admixture during concrete production in order to introduce artificial air pores. This is disclosed by JP 4317447, which improves the pore properties and thus the freeze-thaw properties by combining addition of an air pore former and fly ash. The air pore volume is then available as expansion space for, for example, freezing water. In order to make concrete constructions durable, an attempt is made, firstly, to reduce the water absorption. This can be effected by hydrophobicization, for example as described in EP 913 370. However, the freeze-thaw resistance should also be improved.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right to disclaim, and hereby disclose a disclaimer of any previously described product, method of making the product, or process of using the product.

### SUMMARY OF THE INVENTION

It was an object of the present invention to develop a composition and a process for producing it, which lead to cured building materials such as concrete, mortar, screed or render which have a significantly improved freeze-thaw resistance and at the same time have hydrophobic properties. A further object was to provide products which achieve the abovementioned objects and can be used in a simple way by the user.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

It has surprisingly been found that a specific combination of fly ash, silica dust and organofunctional silicon compounds, in each case in a specific amount based on the weight of cement, makes it possible to produce hydraulically curable compositions which after addition of further customary constituents and water form cured building materials which are hydrophobicized throughout their body and nevertheless have a significantly improved freeze-thaw resistance. Completely surprisingly, a sufficient number and size of air pores can be obtained despite internal hydrophobicization of the concrete, screed or render. Here, the combination according to the invention of particular hydrophobicizing agents such as organofunctional silicon compounds with silica dust at the same time achieves hydrophobicization and particular setting of a dense microstructure, with an air pore microstructure having significantly improved freeze-thaw properties being additionally achieved in the cured building materials as a result of the combination according to the invention comprising fly ash.

The invention provides a hydraulically curable composition, in particular for producing concrete, mortar, screed, render, which has improved freeze-thaw resistance and preferably an air pore content of from 1 to 7%, preferably from 3 to 7%, determined in accordance with SIA 262 and which comprises the constituents cement, additional constituents, organofunctional silicon compounds and optionally aggregates; for example concrete aggregates such as rock particles, in particular gravel, crushed material or sand; and optionally admixtures, where the composition contains the constituents
additional constituents comprising fly ash and silica dust, in particular as dust, or in a formulation, for example as dispersion, in particular as aqueous suspension, where the fly ash and the silica dust are in each case independently present in an amount based on the weight of cement of from 1 to 25% by weight, optionally together with further additional constituents, and
the organofunctional silicon compounds are present in an amount of from 0.1 to 5% by weight based on the weight of cement, with particular preference being given to the additional constituents fly ash and silica dust being present, in each case independently, in an amount based on the weight of cement of from 5 to 20% by weight, preferably from 5 to 15% by weight, in the composition.

More preferably, the additional constituent fly ash is present in an amount of from 5 to 15% by weight and the additional constituent silica dust is present in an amount of from 5 to 15% by weight, based on the weight of cement, and these additives are preferably present in a total amount of not more than 25% by weight and the organofunctional silicon compounds are present in an amount of from 0.1 to 5% by weight, in each case independently based on the weight of cement.

In addition to or as an alternative to one of the abovementioned features, the composition can comprise dry constituents selected from among cement, aggregates, dry additional constituents, dry admixtures and particulately formulated organofunctional silicon compounds and it can comprise constituents selected from among water, liquid additional constituents, liquid admixtures and liquid organofunctional silicon compounds. The preferred dry or liquid constituents of the composition are explained in more detail below.

For the purposes of the present invention, a silica dust, also referred to as fumed silica or microsilica, is a fine siliceous dust having a particle size of only about one tenth of the average particle size of cement. A silica dust is generally used in order to produce a high-strength concrete. The mode of action of silica dust is based on it filling the pore spaces between the cement particles better and thus leading to an increased density of the cement block microstructure. In addition, silica dust improves the bond between the aggregates, i.e. the rock particles. According to the invention, the silica dust can be used as dust, as dispersion, in particular as suspension. The abovementioned forms to be added are always encompassed below whenever silica dust is mentioned. A customary average particle size of silica dust is in the range from 0.1 to 0.5 μm, and it generally comprises from 80 to 99% by weight of silicon dioxide and from 0.1 to 3% by weight of aluminium oxide (Al₂O₃), from 0.1 to 5% by weight of Fe₂O₃ and from 0.7 to 2.5% by weight of calcium oxide.

A fly ash can generally have an average particle size of from 10 to 30 μm, with the fly ash generally additionally containing silicon dioxide, aluminium oxide, iron oxide and calcium oxide in various proportions. A fly ash for concrete is defined in EN 450-1 as finely particulate dust which consists mainly of spherical, vitreous particles and is obtained in the combustion of finely milled coal with or without concomitant combustion material(s) and which consists essentially of SiO₂ and Al₂O₃, where the content of reactive SiO₂ as prescribed and described in EN 197-1 is at least 25% by mass. Fly ash can be treated by classification, selection, sieving, drying, mixing, milling, reduction of the carbon content or by a combination of these processes in suitable production plants.

In addition to or as an alternative to one of the abovementioned features, particular preference can be given to the additional constituents fly ash and silica dust being present in a ratio of from 1:10 to 10:1, in particular in a ratio of from 1:7 to 7:1, preferably from 1:5 to 5:1, particularly preferably from 1:3 to 3:1, more preferably from 1:2 to 2:1, with further preference being given to these additives each being independently present in an amount of from 5 to 15% by weight based on the weight of cement. The fly ash and the silica dust can usually be present in an approximate ratio of 1:1 to one another, in each case plus/minus 0.2, and in each case in an amount based on the weight of cement of from 1 to 25% by weight, preferably from 5 to 20% by weight, particularly preferably from 5 to 15% by weight.

Organofunctional silicon compounds which can be used according to the invention are particularly preferably alkoxyalkylsilanes, the alkylsilanols formed correspondingly by hydrolysis and/or condensation and also oligomeric alkyl-functional siloxanes. In general, alkylsilanes, alkylsilanols and alkylsiloxanes are preferred in the combination with fly ash and silica dust.

For the purposes of the invention, organofunctional silicon compounds are the following, which can be present in monomeric and/or oligomeric form and in which the silicon atoms are R²O—Si—R¹-functionalized, where R¹ corresponds to a monofunctional C-terminated organofunctional radical, preferably a linear, branched and/or cyclic alkyl or alkenyl radical comprising, in particular, from 2 to 18 carbon atoms, and R² can independently be hydrogen, a linear, branched and/or cyclic alkyl radical having from 1 to 8, in particular from 1 to 4, carbon atoms or a polyethylene oxide, polymethylene oxide, hydroxyalkyl, dihydroxyalkyl or aminoalkyl radical or a hydroxy-functionalized aminoalkyl radical having in each case independently from 1 to 18 carbon atoms, preferably from 2 to 10 carbon atoms, in the alkyl, where the silicon compounds can also be present as alkoxysilane, silanol or as at least partially hydrolysed and/or condensed siloxane or as a mixture of these. Oligomeric siloxanes preferably have a degree of oligomerization of from 2 to 30 silicon atoms in the siloxane, preferably from 2 to 20 silicon atoms, more preferably from 2 to 4 silicon atoms. The oligomeric siloxanes can be based on homocondensates, cocondensates or block cocondensates or mixtures with silanes or silanols, in particular derived from the general formula I.

Organofunctional silicon compounds which have been found to be particularly suitable are those of the general formula I

R¹—Si(R³)ₓ(OR²)₃₋ₓ (I)

or the silanols, oligomeric siloxanes or mixtures thereof derived therefrom by hydrolysis and/or condensation or compositions comprising these, where
R¹ is in each case independently a linear, branched or cyclic alkyl radical having from 2 to 18 carbon atoms or an alkylene radical having from 2 to 18 carbon atoms, in each case independently preferably having from 2 to 10 carbon atoms, and
R² is independently hydrogen, a linear, branched and/or cyclic alkyl radical having from 1 to 4 carbon atoms, a polyethylene oxide, polymethylene oxide, hydroxyalkyl, dihydroxyalkyl, aminoalkyl, hydroxy-functionalized aminoalkyl radical having in each case from 1 to 18 carbon atoms in the alkyl, in particular having from 2 to 10 carbon atoms, and
R³ is a linear, branched or cyclic alkyl radical having from 1 to 8 carbon atoms, in particular from 1 to 4 carbon atoms, or an aryl radical and x=0 or 1, with preference being given to x=0.

As organofunctional silicon compounds of the formula I, preference is given to alkyltrialkoxysilanes, dialkyldialkoxysilanes, where the alkyl groups present can be linear and/or branched alkyl groups having from 2 to 18 carbon atoms per alkyl group and alkoxy groups present can be linear and/or branched alkoxy radicals having from 1 to 4 carbon atoms, with preference being given to using methoxy, ethoxy and/or i-propoxy groups as OR². In addition, a copolymerizable alkylene radical, for example a vinyl and/or allyl radical, can also be present instead of an alkyl group.

Nonlimiting examples of preferred organofunctional silicon compounds for the purposes of the present invention are organofunctional silanes or siloxanes selected from the group consisting of alkoxysilanes such as alkylsilanes, e.g. methyltrimethoxysilane, methyltriethoxysilane, methyltripropoxysilane, ethyltrimethoxysilane, ethyltriethoxysilane, n-propyltrimethoxysilane, n-propyltriethoxysilane, i-propyltrimethoxysilane, i-propyltriethoxysilane, butyltrimethoxysilane, i-butyltriethoxysilane, i-pentyltrimethoxysilane, pentyltriethoxysilane, i-hexyltrimethoxysilane, i-octyltrimethoxysilane, octyltriethoxysilane, hexadecyltrimethoxysilane, hexadecyltriethoxysilane, octadecyltrimethoxysilane, octadecyltriethoxysilane, dimethyldimethoxysilane, dimethyldiethoxysilane, i-butylmethyldimethoxysilane, i-butylmethyldiethoxysilane, cyclohexylmethyldimethoxysilane, diisopropyldimethoxysilane, diisobutyldimethoxysilane and isobutylisopropyldimethoxysilane, vinylsilanes, e.g. vinyltrimethoxysilane, vinyltriethoxysilane, vinylmethyldialkoxysilane, vinyltris(2-methoxyethoxysilane), and the homocondensates, cocondensates or block cocondensates of the abovementioned compounds formed in each case by at least partial hydrolysis and/or condensation. For example alkylalkoxysiloxanes having a degree of oligomerization of from 2 to 30, preferably an average of from 2 to 18. For the purposes of the invention, preference can also be given to using silanes of compounds of the formula I, in particular propyltrialkoxysilanes, i.e. preferably alkyltriethoxysiloxanes, particularly preferably having short-chain alkyl radicals, e.g. from 2 to 6 carbon atoms in R′.

For the purposes of the invention, the term cement encompasses, in particular, a portland cement, for example as per EN 196 CEM I, II, III, IV and V, high-alumina cement, fast-setting cement, fibrocement, special cements or spray cement and also the cements mentioned in EN 197-1.

Particularly preferred hydraulically curable compositions, kits or formulations comprise an air pore former in an amount based on the weight of cement in the range from 0.1 to 2% by weight, preferably in the range from 0.5 to 1% by weight and particularly preferably in the range from 0.5 to 0.9% by weight. Suitable air pore formers are, for example, those based on tall and/or balsam resins, lignosulphonates, protein acids, alkyl polyglycol ethers, e.g. Micro-Air 107-5 (obtainable from BASF AG).

A preferred composition additionally contains a plasticizer or fluidizer in a low concentration, for example in the range from 0.1 to 2% by weight based on the weight of cement, in particular in the range from 0.5 to 1.5% by weight. Suitable plasticizers are based, for example, on polycarboxylates, e.g. Glenium SKY 584 (obtainable from BASF AG) or melamine-formaldehyde sulphonates, naphthalene-formaldehyde sulphonates, hydroxycarboxylic acids and salts thereof and/or lignosulphonates.

Furthermore, preference is given to compositions which have an accelerator, for example a polycarboxylate ether, in the hydraulically curable composition. However, further preference is given to compositions which make do without the addition of an accelerator. A suitable accelerator is, for example, Q-flash 10h (obtainable from Concreturn AG) or calcium sulphoaluminate, formates, arenesulphonic acids, polycarboxylate ethers and/or calcium chloride.

In addition to one or more of the above features, the hydraulically curable composition comprises, as dry constituents, cement, optionally aggregates such as rock particles, sand, gravel, crushed rock or synthetic, granulated aggregates such as granulated synthetic rock, glass, etc., in particular having a particle size in the range from 0.01 to 50 mm, which in each case have a particle size of from 0 to 0.125 mm (fillers, ground rock), from 0 to <4 mm (fine rock particles, sand, crushed sand) or as smallest particle size greater than 2 mm and as greatest particle size greater than 4 mm (pebbles, crushed rock, gravel) or a particle size mixture having particles larger than 0 mm and also larger than 4 mm (gravel sand, crushed rock sand); and optionally dry additional constituents and/or optionally dry admixtures, optionally organofunctional silicon compounds.

In addition to one or more of the above features, the hydraulically curable composition comprises, as liquid constituents, water and optionally liquid additional constituents and/or optionally liquid admixtures and/or optionally also organofunctional silicon compounds, preferably an oil-in-water emulsion containing organofunctional silicon compounds.

Dry additional constituents encompass: pozzolanic additional constituents such as trass, fly ash; fibrous additional constituents such as steel fibres, glass fibres, polymer fibres, cellulose; latently hydraulic materials such as slag sand; quartz flour, ground limestone, further pigments, fly ash, trass, silica dust, organic additional constituents.

Liquid additional constituents encompass: silica dust suspensions; organic additional constituents such as resins, synthetic resin dispersions.

Admixtures, which can be present in dry or liquid form and are therefore present as liquid constituent or dry constituent in the composition, encompass: fluidizers (concrete fluidizers, plasticizers) such as polycarboxylate ethers (PCEs), polymethyl methacylates or lignosulphonates or naphthalene-formaldehyde sulphonates; retarders, air pore formers, sealants, curing accelerators, solidification accelerators, stabilizers, chromate reducers, recycling auxiliaries, foaming agents, sedimentation reducers, dispersants or wetting agents such as siliconates or alkylphosphonates, antifoams such as trialkyl phosphates, as air pore formers for example hydrolysed resin acids and/or water reducers.

EN 934-2 defines the admixtures for concrete, mortar and injection mortar.

Concrete produced from a hydraulically curable composition according to the invention usually comprises a mixture of cement, aggregates such as rock particles, in particular sand and gravel or crushed material; and water (make-up water). The concrete can additionally contain additional constituents and/or admixtures. The concrete can additionally comprise steel elements such as steel reinforcement or as fibrous concrete fibres composed of steel, plastic (for example polypropylene), cellulose and/or glass. A customary mortar likewise comprises cement and optionally lime as binder and rock particles whose particle size generally does not exceed 4 mm; mortar optionally also contains additional constituents and admixtures, and also added water. Mortar is employed for joining masonry bricks and for rendering walls and ceilings. The hydraulically curable composition can also be employed as plaster or render by applying a coating of mortar, in particular render mortar, which can preferably be applied to exterior and/or interior walls and also ceilings. The render mortar also comprises, in the hydraulically curable composition, cement and optionally lime as binder, aggregates and additional constituents or admixtures. A render mortar can, depending on the type of use, be employed for various purposes. These encompass production of a smooth substrate for tiles, painting or wall coverings, regulation of the humidity of the room in the case of interior renders, thermal insulation and repelling of water in the case of exterior renders and production of an aesthetic appearance. Screeds according to the invention are also mortar layers of the hydraulically curable composition, which are applied as flooring to a load-bearing substrate or to intermediate separation or insulation layers.

The invention likewise provides a process for producing a hydraulically curable composition and also a composition, in particular a concrete, mortar, screed or render, which can be obtained by this process, wherein the process comprises the following steps
1. mixing of the dry constituents of the hydraulically curable composition, comprising cement, fly ash and optionally silica dust and optionally particulately formulated organofunctional silicon compounds,
2. addition of liquid constituents of the hydraulically curable composition, comprising water, optionally silica dust in an aqueous suspension and optionally liquid or dispersed, in particular dispersed in water, organofunctional silicon compounds.

In the process of the invention, fly ash and silica dust are particularly preferably added, in each case independently, in an amount of from 1 to 25% by weight based on the weight of cement, with further preference being given to fly ash being added in an amount of from 5 to 15% by weight, silica dust including silica dust in suspension being added in an amount of from 5 to 15% by weight and the organofunctional silicon compounds being added in an amount of from 0.1 to 5% by weight, in each case independently based on the weight of cement.

In addition to or as an alternative to one of the abovementioned features, further preference can be given to the additional constituents fly ash and silica dust or silica dust in suspension being added in a ratio of from 1:10 to 10:1, in particular in a ratio of from 1:7 to 7:1, preferably in a ratio of from 1:5 to 5:1, particularly preferably from 1:3 to 3:1, more preferably from 1:2 to 2:1, with further preference being given to them being added, in each case independently, in an amount of from 5 to 15% by weight based on the weight of cement. More preferably, they can also be added in a ratio of about 1:1 plus/minus in each case 0.2 and based on the weight of cement in an amount of from 1 to 25% by weight.

The process of the invention further comprises the addition of water or make-up water to the hydraulically curable composition and also a composition or a shaped object which can be obtained by this process by subsequently introducing the hydraulic composition admixed with water into shuttering or a mould and allowing it to cure. The mineral building materials, e.g. concrete, mortar, screed or render, produced by the process of the invention are hydrophobicized in the body and have an air pore content in the range from 1 to 7%, preferably from 3 to 7%, determined in accordance with SIA 262.

The total amount of water (in kg/m³) added to the mixture is in a fixed ratio to the amount of binder used, in particular to the amount of cement used (likewise in kg/m³). Thus, the ratio of water to cement can be 0.2-0.9 including all numbers in between, preferably 0.25-0.8 including all numbers in between, particularly preferably 0.3-0.7 including all numbers in between.

The invention likewise provides a kit for a composition according to the invention or for use in a process according to the invention, which comprises
a) fly ash and silica dust in a formulation with optionally auxiliaries and a separate formulation of organofunctional silicon compounds, the separate formulation is in particular solid but can advantageously also be a liquid formulation, optionally with auxiliaries, or
b) fly ash and a separate formulation comprising silica dust and organofunctional silicon compounds and optionally auxiliaries, or
c) fly ash, silica dust and organofunctional silicon compounds each separated from one another by packaging, optionally in each case independently formulated with auxiliaries, in a fixed ratio to one another.

In a kit according to the invention or a formulation according to the invention, it can be preferred that the fly ash is present in a ratio to the silica dust of from 1:10 to 10:1, in particular with the organofunctional silicon compounds being additionally present in a ratio to the total weight of fly ash and silica dust of from 1:15 to 1:2; the silicon compound is particularly preferably present in a ratio to the total weight of fly ash and silica dust of from 1:10 to 1:5. The kit can, for example, comprise two separate packagings such as cardboard containers, plastic bags or the like into which the organofunctional silicon compounds and the fly ash together with the silica dust have been dispensed separately from one another.

The invention likewise provides a spray-dried formulation which is soluble or dispersible in water and can be used, in particular, in a hydraulically curable composition according to the invention or a process according to the invention, where the formulation comprises organofunctional silicon compounds of the general formula I and/or silanols, oligomeric siloxanes or mixtures thereof derived therefrom by hydrolysis and/or condensation and contains at least one water-soluble organic polymer, preferably a polyvinyl alcohol, in an amount of from 35 to 80% by weight, in particular from 40 to 80% by weight, based on the total weight of the organic polymer, in particular the polyvinyl alcohol, and the organofunctional silicon compounds. Particularly preferred water-soluble polymers are, in addition to polyvinyl alcohol, also polyvinyl acetate, polyvinylpyrrolidone, polyacrylates, starches, starch derivatives, polymethacrylates, polymaleates and/or polyalkylene oxide and also water-soluble cellulose ethers, water-soluble polyethylene oxides or water-soluble proteins.

The spray-dried formulation can advantageously be added in a simple and economical way to the dry constituents of the hydraulically curable composition and mixed therewith. As an alternative, it can also be dispersed and/or dissolved in the make-up water and subsequently added to the dry constituents of the composition.

The invention likewise provides for the combined use of fly ash, silica dust and organofunctional silicon compounds, in particular of the general formula I, or silanols, oligomeric siloxanes or mixtures thereof derived therefrom by hydrolysis and/or condensation in hydraulically curable compositions for improving the freeze-thaw resistance of concrete, mortar, screed, render and components made therefrom, e.g. pipes, synthetic blocks or moulded blocks. Particular preference is given to alkyl-functional organofunctional silicon compounds being added together with fly ash and silica dust in the abovementioned ratio to the cement in order to achieve the advantageous effects according to the invention in the cured building material, viz. the concrete, mortar, screed or render.

The invention likewise provides for the combined use of fly ash, silica dust and organofunctional silicon compounds, in particular of the general formula I, or silanols, oligomeric siloxanes or mixtures thereof derived therefrom by hydrolysis and/or condensation in hydraulically curable compositions for producing concrete, mortar, screed, render and components made therefrom, e.g. pipes, synthetic blocks or moulded blocks, having an air pore content of from 1 to 7%, in particular having an air pore content of from 3 to 7%, preferably from 3 to 6% (in % by volume), determined in accordance with SIA 262. Particular preference is given to alkyl-functional organofunctional silicon compounds being added together with fly ash and silica dust in the abovementioned ratio to the cement in order to achieve the advantageous effects according to the invention in the cured building material, viz. the concrete, mortar, screed or render.

The concrete here can be a steel-reinforced concrete, expanded concrete, gas concrete, porous concrete, rolled concrete, centrifugally applied concrete, screed concrete, gravel concrete, drainage concrete, high-strength and ultrahigh-strength concrete, a spray concrete, fibrous concrete, lightweight concrete, standard concrete, heavy concrete, a special concrete which cures under water, facing concrete, self-cleaning concrete, self-compacting concrete, translucent concrete, high-performance concrete, prestressed concrete, textile concrete, tamped concrete or further types of concrete, mortar, render and screed known to those skilled in the art.

The following examples illustrate the invention without restricting it to these working examples.

### EXAMPLES

### General Working Example

All concrete specimens were produced in accordance with the requirements of Ö-NORM 3303. The amounts added were correspondingly used in kg/m³. The raw materials indicated were placed in a 701 mechanical mixer. The coarse rock particles, then the fine rock particles, then the cement and finally the remaining solid additional constituents were introduced in succession into the mixer. This dry mixture was premixed for 30 s. The make-up water was subsequently introduced together with further liquid constituents and the resulting mixture was mixed for a further 3 minutes. Test cubes having edge lengths of 150 mm were cast. After curing for 48 hours at 20° C. and 99% relative humidity, the specimens were removed from the formwork. The test specimens were stored in accordance with Ö-NORM 3303 chapter 5.1.3 section 5.5 until the respective test.

Mixtures:

| | Example | | | | |
|---|---|---|---|---|---|
| | 1 (com- | 2 (com- | | | |
| | parison) | parison) | 3 | 4 | 5 |
| Cement^{[1]} | 410 | 410 | 410 | 410 | 410 |
| Fluasit (fly ash) | — | — | 50 | 50 | 50 |
| SikaFume | — | — | 50 | 50 | 50 |
| (silica dust) | | | | | |
| Crushed sand | 288 | 288 | 265 | 260 | 268 |
| [0-2 mm] | | | | | |
| Crushed sand | 102 | 102 | 94 | 92 | 92 |
| [1-4 mm] | | | | | |
| Crushed rock | 339 | 339 | 312 | 306 | 308 |
| [4-16 mm] | | | | | |
| Crushed rock | 475 | 475 | 437 | 428 | 431 |
| [16-32 mm] | | | | | |
| Porphyry [0-4 mm] | 477 | 477 | 452 | 444 | 447 |
| Water | 170 | 170 | 210 | 185 | 184 |
| Glenium SKY 584 | 3.69 | 3.69 | 4.1 | — | — |
| Micro-Air 107-5 | 0.29 | 0.29 | 2.87 | 4.10 | 3.69 |
| Internal hydro- | — | 16.4 | 8.2 | 7.18 | 6.15 |
| phobicization^{[2]} | | | | | |
| Q-flash 10 h (l) | — | — | — | 6.15 | 6.15 |

^{[1]}CEM II/A-S 42,5 R
^{[2]}a powder containing 50% by weight of oligo(propylethoxysiloxane) embedded in a polyvinyl alcohol (PVA having a degree of hydrolysis of 88 mol % and a Höppler viscosity as 4% solution of 4 mPa s) was used as internal hydrophobicizing agent.
Glenium SKY 584 is a plasticizer based on polycarboxylate
Micro-Air 107-5 is an air pore former based on modified tall and balsam resins
Q-flash 10 h is an accelerator based on polycarboxylate ether

Test Results:

| | Example | | | | |
|---|---|---|---|---|---|
| | 1 (com- | 2 (com- | | | |
| | parison) | parison) | 3 | 4 | 5 |
| Compressive | 23.45 | 20.88 | 23.78 | 24.63 | 29.22 |
| strength after 2 d | | | | | |
| [MPa]:^{[3]} | | | | | |
| Compressive | 44.34 | 42.62 | 44.22 | 53.14 | 46.04 |
| strength after 28 d | | | | | |
| [MPa]:^{[3]} | | | | | |
| Degree of settling | 55 | 200 | 70 | 170 | 70 |
| [mm]:^{[4]} | | | | | |
| Density [g/l]:^{[4]} | 2334 | 2382 | 2260 | 2216 | 2222 |
| Air pores [%]:^{[4]} | 3.4 | 1.4 | 4.6 | n.d. | 5.6 |
| Weathering loss | 857.5 | 2660.7 | 87.4 | 169.5 | 216.5 |
| after 28 freeze/- | | | | | |
| thaw cycles | | | | | |
| [g/m²]:^{[4]} | | | | | |
| Water penetration | 21 | 10 | 6 | 8 | 9 |
| depth [mm]^{[5]} | | | | | |

n.d.: not determined
^{[3]}in accordance with SN EN 12390-3
^{[4]}in accordance with SIA 262
^{[5]}in accordance with EN 12390-8

It is clear from Examples 1 to 5 that the addition of the internal hydrophobicizing agent to the composition brings about the desired significant reduction in the water absorption. At the same time, a (desirable) plasticizing effect is achieved.

However, it is also clear from Comparative Examples 1 and 2 that the addition of the internal hydrophobicizing agent without further measures leads to a reduction in the air pore content and to a large increase in the weathering loss in the freeze/thaw test. In addition, the compressive strength is reduced somewhat.

One of the mixtures according to the invention, namely that in Example 3, demonstrates that the additional use of fly ash and microsilica when using the internal hydrophobicizing agent enables a significant increase in the air pore content and a significantly lower weathering loss in the freeze/thaw test to be achieved. This is with retention of other important concrete properties such as density, processability and compressive strength.

Finally, the mixtures according to the invention in Examples 4 and 5 show that the desired property of a reduced weathering loss in the freeze/thaw test can also be achieved when fly ash and microsilica are added together with the internal hydrophobicization and at the same time the air pore former is replaced by a concrete accelerator. The early strengths in particular are influenced further in a positive way as a result.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A hydraulically curable composition comprising:
cement;
additional constituents;
organofunctional silicon compounds;
fly ash;
silica dust;
optionally aggregates; and
optionally admixtures;
wherein the fly ash is present in an amount of from 1 to 25% by weight based on the weight of cement;
wherein the silica dust is present in an amount of from 1 to 25% by weight based on the weight of cement; and
wherein the organofunctional silicon compounds are present in an amount of from 0.1 to 5% by weight based on the weight of cement.

2. The composition according to claim 1;
wherein the fly ash is present in an amount of from 5 to 20% by weight based on the weight of cement; and
wherein the silica dust is present in an amount of from 5 to 20% by weight based on the weight of cement.

3. The composition according to claim 1;
characterized in that
wherein the fly ash is present in an amount of from 5 to 15% by weight based on the weight of cement;
wherein the silica dust is present in an amount of from 5 to 15% by weight based on the weight of cement; and
wherein the organofunctional silicon compounds are present in an amount of from 0.1 to 5% by weigh based on the weight of cement.

4. The composition according to claim 1;
wherein the fly ash and the silica dust are present in a ratio of from 1:10 to 10:1.

5. The composition according to claim 1;
wherein the organofunctional silicon compounds are monomeric and/or oligomeric; and
wherein the silicon atoms are R²O—Si—R¹-functionalized, where:
each radical R¹, independently of one another, corresponds to a monofunctional C-terminated organofunctional radical; and
each radical R², independently of one another, is:
hydrogen;
a linear, branched, and/or cyclic alkyl radical having from 1 to 4 carbon atoms;
a polyethylene oxide or polymethylene oxide; or
a hydroxyalkyl, dihydroxyalkyl, aminoalkyl, or hydroxy-functionalized aminoalkyl radical, having in each case from 1 to 18 carbon atoms in the alkyl; and
wherein the silicon compounds are present as alkoxysilane, as silanol, as at least partially hydrolysed and/or condensed siloxane, or as a mixture thereof.

6. The composition according to claim 1;
wherein the organofunctional silicon compounds:
correspond to the general formula I:
R¹—Si(R³)ₓ(OR²)₃₋ₓ (I); or
comprise silanols, oligomeric siloxanes, or mixtures thereof, derived from a compound of the general formula I by hydrolysis and/or condensation;
where:
R¹ is in each case independently:
a linear, branched, or cyclic alkyl radical having from 2 to 18 carbon atoms; or
an alkylene radical having from 2 to 18 carbon atoms;
R² is independently:
hydrogen;
a linear, branched, and/or cyclic alkyl radical having from 1 to 4 carbon atoms;
a polyethylene oxide or polymethylene oxide; or
a hydroxyalkyl, dihydroxyalkyl, aminoalkyl, or hydroxy-functionalized aminoalkyl radical, having in each case from 1 to 18 carbon atoms in the alkyl;
R³ is independently a linear, branched, or cyclic alkyl radical having from 1 to 8 carbon atoms, or an aryl radical; and
x=0 or 1.

7. The composition according to claim 1, further comprising:
a dry constituent selected from the group consisting of:
cement, aggregates, dry additional constituents, dry admixtures, and particulately formulated organofunctional silicon compounds; and
a liquid constituent selected from the group consisting of:
water, liquid additional constituents, liquid admixtures, and liquid organofunctional silicon compounds.

8. A process for producing a hydraulically curable composition according to claim 1, comprising:
mixing dry constituents of the hydraulically curable composition, the dry constituents comprising:
cement;
fly ash;
optionally silica dust; and
optionally particulately formulated organofunctional silicon compounds; and
adding liquid constituents of the hydraulically curable composition, the liquid constituents comprising:
water;
optionally silica dust in a suspension; and
optionally liquid or dispersed organofunctional silicon compounds.

9. The process according to claim 8;
wherein the fly ash is present in an amount of from 5 to 15% by weight based on the weight of cement;
wherein the silica dust or silica dust in suspension is present in an amount of from 5 to 15% by weight based on the weight of cement; and
wherein the organofunctional silicon compounds are present in an amount of from 0.1 to 5% by weight based on the weight of cement.

10. The process according to claim 8;
wherein the fly ash, and the silica dust or silica dust in suspension, are added in a ratio of from 1:10 to 10:1, in particular in a ratio of from 1:7 to 7:1, preferably in a ratio of from 1:5 to 5:1, particularly preferably from 1:3 to 3:1, more preferably from 1:2 to 2:1, with further preference being given to them being added, in each case independently, in an amount of from 5 to 15% by weight based on the weight of cement.

11. (canceled)

12. A kit for a composition according to claim 1, comprising:
(a) fly ash and silica dust in a formulation with optionally auxiliaries, and a separate formulation of organofunctional silicon compounds, optionally with auxiliaries; or
(b) fly ash and a separate formulation comprising silica dust and organofunctional silicon compounds and optionally auxiliaries; or
(c) fly ash, silica dust, and organofunctional silicon compounds, each separated from one another by packaging, optionally in each case independently formulated with auxiliaries, in a fixed ratio to one another.

13. The kit according to claim 12,
wherein the fly ash is present in a ratio to the silica dust of from 1:10 to 10:1.

14. A spray-dried formulation which is soluble or dispersible in water, comprising:
organofunctional silicon compounds; and
at least one water-soluble organic polymer in an amount of from 35.0 to 80.0% by weight based on the total weight of the organic polymer and the organofunctional silicon compounds;
wherein the organofunctional silicon compounds:
correspond to the general formula I:
R¹—Si(R³)ₓ(OR²)₃₋ₓ (I); and/or
comprise silanols, oligimeric siloxanes, or mixtures thereof, derived from a compound of the general formula I by hydrolysis and/or condensation;
where:
R¹ is in each case independently:
a linear, branched, or cyclic alkyl radical having from 2 to 18 carbon atoms; or
an alkylene radical having from 2 to 18 carbon atoms;
R² is independently:
hydrogen;
a linear, branched, and/or cyclic alkyl radical having from to 4 carbon atoms;
a polyethylene oxide or polymethylene oxide; or
a hydroxyalkyl, dihydroxyalkyl, aminoalkyl, or hydroxy-functionalized aminoalkyl radical, having in each case from 1 to 18 carbon atoms in the alkyl;
R³ is independently a linear, branched, or cyclic alkyl radical haying from 1 to 8 carbon atoms, or an aryl radical; and
x=0 or 1.

15. A method comprising:
utilizing the hydraulically curable compositions according to claim 1 to improve the freeze-thaw resistance of concrete, mortar, screed, render, or a component made therefrom.

16. A method comprising:
utilizing the hydraulically curable compositions to producing concrete, mortar, screed, render, or a component made therefrom, having an air pore content of from 1 to 7% determined in accordance with SIA 262.

17. The composition according to claim 2;
wherein the fly ash is present in an amount of from 5 to 15% by weight based on the weight of cement; and
wherein the silica dust is present in an amount of from 5 to 15% by weight based on the weight of cement.

18. The composition according to claim 4;
wherein the fly ash and the silica dust are present in a ratio of from 1:7 to 7:1.

19. The composition according to claim 18;
wherein the fly ash and the silica dust are present in a ratio of from 1:5 to 5:1.

20. The composition according to claim 19;
wherein the fly ash and the silica dust are present in a ratio of from 1:3 to 3:1.

21. The composition according to claim 20;
wherein the fly ash and the silica dust are present in a ratio of from 1:2 to 2:1.

22. The composition according to claim 17;
wherein the fly ash and the silica dust are present in a ratio of from 1:10 to 10:1.

23. The composition according to claim 22;
wherein the fly ash and the silica dust are present in a ratio of from 1:7 to 7:1.

24. The composition according to claim 23;
wherein the fly ash and the silica dust are present in a ratio of from 1:5 to 5:1.

25. The composition according to claim 24;
wherein the fly ash and the silica dust are present in a ratio of from 1:3 to 3:1.

26. The composition according to claim 25;
wherein the fly ash and the silica dust are present in a ratio of preferably from 1:2 to 2:1.

27. The process according to claim 10;
wherein the fly ash, and the silica dust or silica dust in suspension, are added in a ratio of from 1:7 to 7:1.

28. The process according to claim 27;
wherein the fly ash, and the silica dust or silica dust in suspension, are added in a ratio of from 1:5 to 5:1.

29. The process according to claim 28;
wherein the fly ash, and the silica dust or silica dust in suspension, are added in a ratio of from 1:3 to 3:1.

30. The process according to claim 29;
wherein the fly ash, and the silica dust or silica dust in suspension, are added in a ratio of from 1:2 to 2:1.

31. The process according to claim 8;
wherein the fly ash is present in an amount of from 5 to 15% by weight based on the weight of cement; and
wherein the silica dust or silica dust in suspension is present in an amount of from 5 to 15% by weight based on the weight of cement.

32. The process according to claim 31;
wherein the fly ash, and the silica dust or silica dust in suspension, are added in a ratio of from 1:10 to 10:1.

33. The process according to claim 32;
wherein the fly ash, and the silica dust or silica dust in suspension, are added in a ratio of from 1:7 to 7:1.

34. The process according to claim 33;
wherein the fly ash, and the silica dust or silica dust in suspension, are added in a ratio of from 1:5 to 5:1.

35. The process according to claim 34;
wherein the fly ash, and the silica dust or silica dust in suspension, are added in a ratio of from 1:3 to 3:1.

36. The process according to claim 35;
wherein the fly ash, and the silica dust or silica dust in suspension, are added in a ratio of from 1:2 to 2:1.
